(19) United States
(12) Patent Application Publication
(10) Pub. No.: US 2023/0014122 A1
(43) Pub. Date: Jan. 19, 2023

(54) MULTIFUNCTIONAL HEATING AND HEAT PRESERVATION CONTAINER, CHARGING BASE AND COMBINATION

(71) Applicant: GUANGDONG JIMI YOUPIN INTELLIGENT TECHNOLOGY CO., LTD., Guangdong Province (CN)

(72) Inventor: Jiangang Ji, Guangdong Province (CN)

(73) Assignee: GUANGDONG JIMI YOUPIN INTELLIGENT TECHNOLOGY CO., LTD., Guangdong Province (CN)

(21) Appl. No.: 17/620,852

(22) PCT Filed: Mar. 26, 2020
(86) PCT No.: PCT/CN2020/081468

§ 371 Date: Dec. 20, 2021

(51) Int. Cl. A47J 41/00; A47G 19/22; A47J 41/02; A47J 27/21

(52) U.S. Cl. CPC A47J 41/005; A47G 19/2288; A47J 41/022; A47J 27/2105; A47J 27/21166

(57) ABSTRACT

Disclosed are a multifunctional heating and heat preservation container and a charging base thereof. The multifunctional heating and heat preservation container comprises a container main body (30), with the container main body (30) comprising a container inner lining (8), and a container housing (10), which forms a vacuum cavity (9) with the container inner lining (8) and enables the bottom of the container inner lining (8) to be exposed, is arranged on the peripheral side of the container inner lining (8). The charging base comprises a base housing (1), an ejector pin (2), which is in contact with a charging ring (214), is arranged in the base housing (1), an insulating layer (3) is sleeved on the ejector pin (2), an elastic member (4) which elastically ejects the ejector pin (2) towards the outside of the base housing (1) to enable the ejector pin (2) to move out of or retract into the base housing (1) is sleeved on the insulating layer (3), and a conductive terminal (5) is connected to the ejector pin (2). The problems whereby a cup body of an existing temperature control cup uses a single-layer steel plate structure, the cup body dissipates heat quickly, and heat preservation completely depends on electric energy heating, such that a battery which is in the temperature control bottom of the container and is used for power supply consumes electricity quickly, are solved; and the problems whereby a spring in an existing charging base is arranged in an ejector pin, and the spring is prone to failure due to an overlarge current in the power-on process of the charging base with the outside, such that the ejector pin cannot rebound and reset, are solved.

### TECHNICAL FIELD

The present application relates to a heating container, particularly a multifunctional heating and heat preservation container, and charging base, and combination.

### BACKGROUND ART

A temperature control cup is a heat preservation container, which is able to heat water, tea, or other beverages placed in the cup to a designated temperature according to needs. An existing temperature control cup is composed of two portions, specifically a cup body for containing water, tea, or other beverages and a temperature control bottom of the container arranged at the bottom of the cup body for heating water, tea, or other beverages in the cup body. Because the cup body of an existing temperature control cup uses a single-layer steel plate structure, the cup body dissipates heat quickly, and heat preservation completely depends on electric heating; in order to maintain a constant temperature, the temperature control bottom of the container has to continually heat up to maintain a constant temperature so that a battery, which is in the temperature control bottom of the container and is used for power supply, consumes electricity quickly.

### SUMMARY OF THE INVENTION

### Technical Issue

The present utility model has made improvements, targeting the problems of the state of the art, whereby a cup body of an existing temperature control cup uses a single-layer steel plate structure, the cup body dissipates heat quickly, and heat preservation completely depends on electric heating so that a battery, which is in the temperature control bottom of the container and is used for power supply, consumes electricity quickly; the technical issue to be solved by the present utility model is to provide a multifunctional heating and heat preservation container.

### Solution to Problems

### Technical Solution

In order to solve the above problems, a multifunctional heating and heat preservation container is disclosed, comprising a container main body;

The container main body comprises a container inner lining; a containing housing, which forms a vacuum cavity with the container inner lining and enables the bottom of the container inner lining to be exposed, is arranged on the peripheral side of the container inner lining.

As an improvement of the multifunctional heating and heat preservation container above, a container support, which enables the bottom of the container inner lining to be exposed, is arranged on the container inner lining; a connecting plate is arranged between the container housing and the container support; the container housing, the container support, the connecting plate, and the side walls of the container inner lining are assembled to form the vacuum cavity.

As an improvement of the multifunctional heating and heat preservation container above, the connecting plate 17 bends upward or downward close to one end of the container support 16.

As an improvement of the multifunctional heating and heat preservation container above, a container support, which enables the bottom of the container inner lining to be exposed, is arranged on the container inner lining; one end of the container support, which is far from the container inner lining, is connected to the container housing; the container housing, the container support, and the side walls of the container inner lining are assembled to form the vacuum cavity.

As an improvement of the multifunctional heating and heat preservation container above, a heating element is arranged on the container inner lining; a temperature control bottom of the container for heating the container main body is arranged on the container main body; the temperature control bottom of the container comprises a base housing arranged on the container housing; a power supply for supplying power to the heating element is arranged in the base housing; the power supply comprises a battery arranged in the base housing; the battery is electrically connected to a control mainboard, a charging ring, and the heating element; one side of the heating ring extends to the exterior of the base housing; a switch for turning on and off the battery is arranged on the base housing; a temperature adjustment touch piece for adjusting the heating temperature is arranged on the base housing.

The present utility model has made improvements, targeting the problems of the state of the art, whereby a spring in an existing charging base is arranged in an ejector pin, and the spring is prone to failure due to an excessive current in the external power-on process of the charging base so that the ejector pin cannot rebound and reset; the technical issue to be solved by the present utility model is to provide a charging base matching the multifunctional heating and heat preservation container.

To solve the technical issues above, a charging base matching the multifunctional heating and heat preservation container is disclosed, comprising a base housing; an ejector pin is arranged in the base housing; an insulating layer is sleeved on the ejector pin; an elastic member, which elastically ejects the ejector pin towards the outside of the base housing to enable the ejector pin to move out of or retract into the base housing, is sleeved on the insulating layer; a conductive terminal is connected to the ejector pin.

As an improvement of the charging base matching the multifunctional heating and heat preservation container above, the base housing comprises a top base housing and a bottom base housing covering the top base housing; a ring groove for placing the elastic member is arranged on the bottom base housing; the ejector pin is arranged in a mounting hole formed by the ring groove.

As an improvement of the charging base matching the multifunctional heating and heat preservation container above, the insulating layer comprises a bottom insulating layer and a top insulating layer arranged on the bottom insulating layer, the conductive terminal is arranged between the bottom insulating layer and the top insulating layer, the elastic member is sleeved on the bottom insulating layer.

As an improvement of the charging base matching the multifunctional heating and heat preservation container above, a through hole, which gradually enlarges towards the direction of the conductive terminal is arranged on the bottom insulating layer, the ejector pin is fitted in the through hole.

As an improvement of the charging base matching the multifunctional heating and heat preservation container above, a limit block for controlling the height of the ejector pin extending outside the base housing is arranged on the ejector pin.

The present utility model has made improvement, targeting the problems of the state of the art, whereby a cup body of an existing temperature control cup uses a single-layer steel plate structure, the cup body dissipates heat quickly, and heat preservation completely depends on electric heating so that a battery, which is in the temperature control bottom of the container and is used for power supply, consumes electricity quickly, a spring in an existing charging base is arranged in an ejector pin, and the spring is prone to failure due to an excessive current in the external power-on process of the charging base so that the ejector pin cannot rebound and reset; the technical issue to be solved by the present utility model is to provide a multifunctional heating and heat preservation container combination.

A multifunctional heating and heat preservation container combination comprises the charging base of the multifunctional heating and heat preservation container above; the multifunctional heating and heat preservation container above is arranged on the charging base of the multifunctional heating and heat preservation container.

Compared with the state of the art, the present utility model has the following advantages:

The present utility model provides a multifunctional heating and heat preservation container, comprising a container main body; the container main body comprises a container inner lining and a container housing; the container housing and the container inner lining form a vacuum cavity, and the container housing does not cover the bottom of the container inner lining. With this structure, the physical characteristic that the vacuum cavity does not conduct heat is leveraged to reduce the speed of decline of the temperature of the water or other liquids placed in the container inner lining so that the matching temperature control bottom of the container does not have to continually heat the container main body to maintain a constant temperature, which reduces power consumption and improves the battery life. The problems, whereby a cup body of an existing temperature control cup uses a single-layer steel plate structure, the cup body dissipates heat quickly, and heat preservation completely depends on electric heating so that a battery, which is in the temperature control bottom of the container and is used for power supply, consumes electricity quickly, are solved.

The present utility model provides a charging base matching the multifunctional heating and heat preservation container, comprising a base housing and an ejector pin in the base housing; an insulating layer is sleeved on the ejector pin; an elastic member is sleeved on the insulating layer. With this structure, no electricity passes through the elastic member while the ejector pin is electrically connected to an external circuit; the problems in the state of the art, whereby a spring in an existing charging base is arranged in an ejector pin, and the spring is prone to losing elasticity due to an excessive current in the external power-on process of the charging base are solved, and the circumstance that the spring loses its elasticity and the ejector pin cannot successfully move out of or retract into the housing is avoided.

### Beneficial Effects of the Invention

### BRIEF DESCRIPTION OF ATTACHED DRAWINGS

### Description of Attached Drawings

In order to more clearly describe the technical solutions in the embodiments of the present application, the attached drawings as described in the embodiments are briefly introduced as follows.

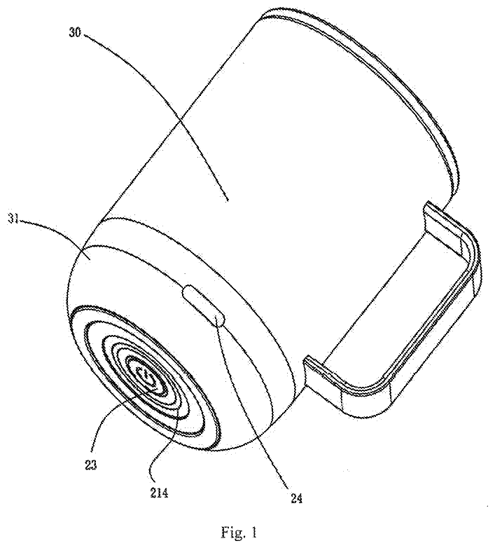

FIG. 1 is a three-dimensional view of a multifunctional heating and heat preservation container of the present application;

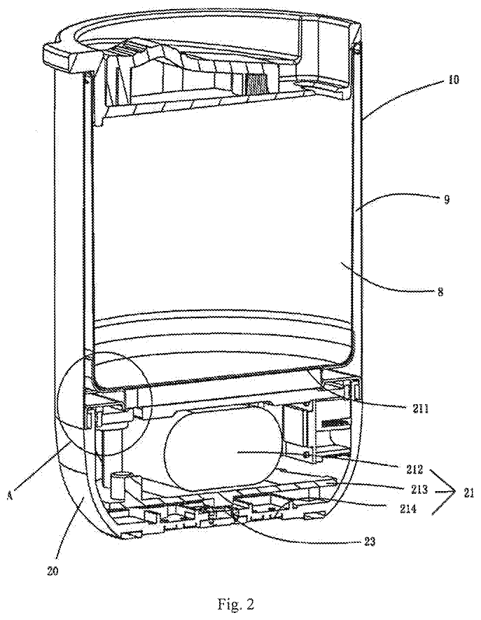

FIG. 2 is a cross-sectional view of a multifunctional heating and heat preservation container of the present application;

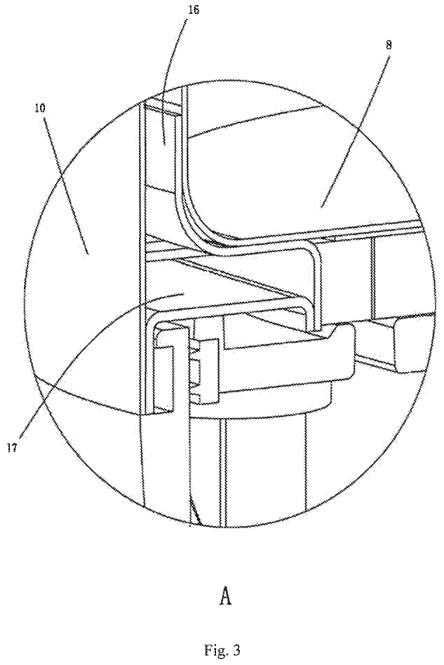

FIG. 3 is a partial enlarged view of A in FIG. 2;

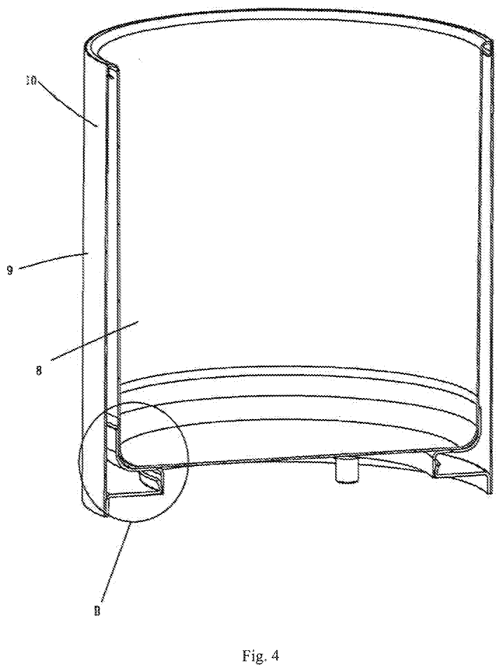

FIG. 4 shows Embodiment 2 of a container main body of a multifunctional heating and heat preservation container of the present application;

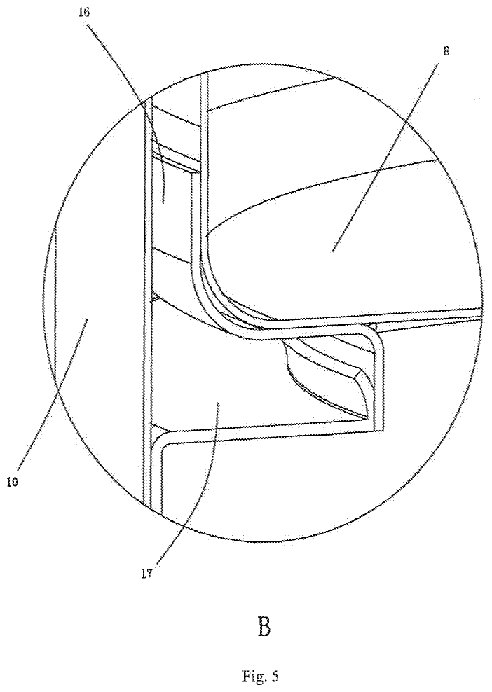

FIG. 5 is a partial enlarged view of B in FIG. 4;

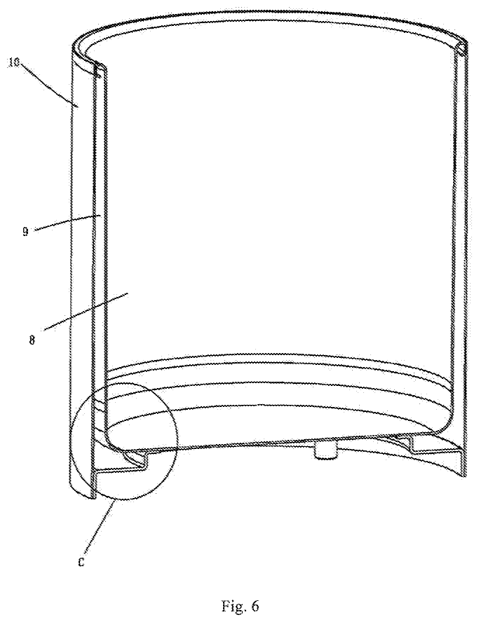

FIG. 6 shows Embodiment 3 of a container main body of a multifunctional heating and heat preservation container of the present application;

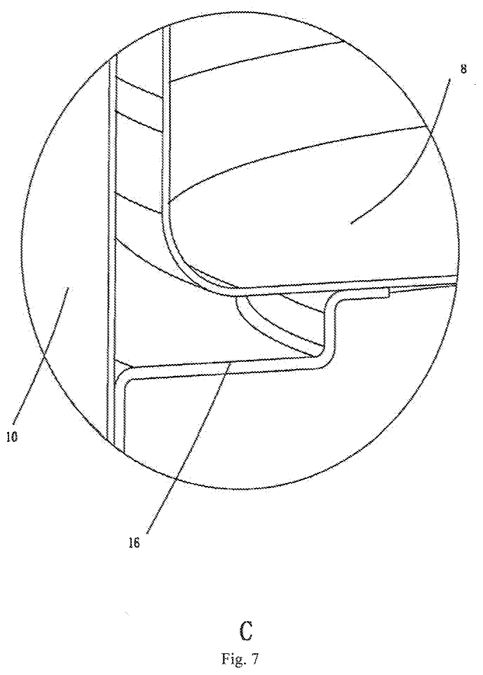

FIG. 7 is a partial enlarged view of C in FIG. 6;

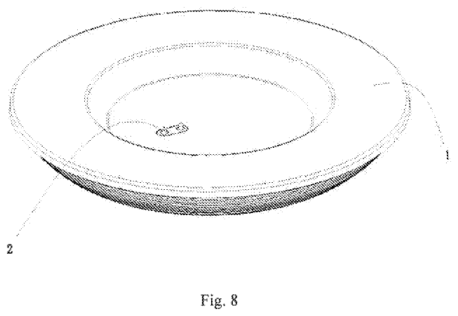

FIG. 8 is a three-dimensional view of a charging base matching a multifunctional heating and heat preservation container of the present application;

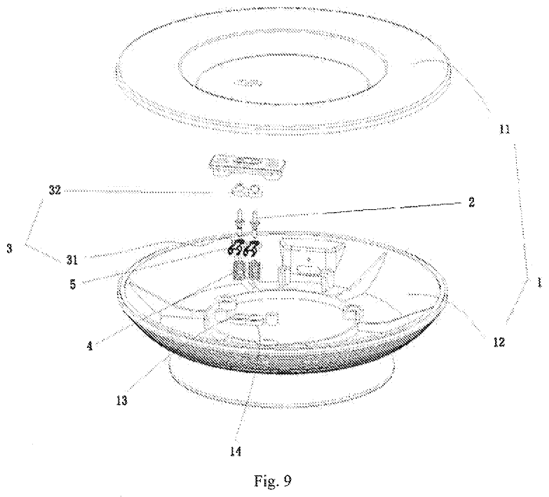

FIG. 9 is an exploded view of a charging base matching a multifunctional heating and heat preservation container of the present application;

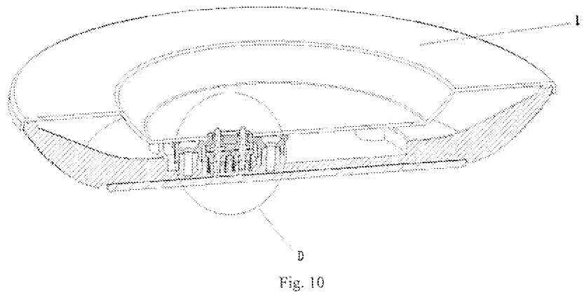

FIG. 10 is a cross-sectional view of a charging base matching a multifunctional heating and heat preservation container of the present application;

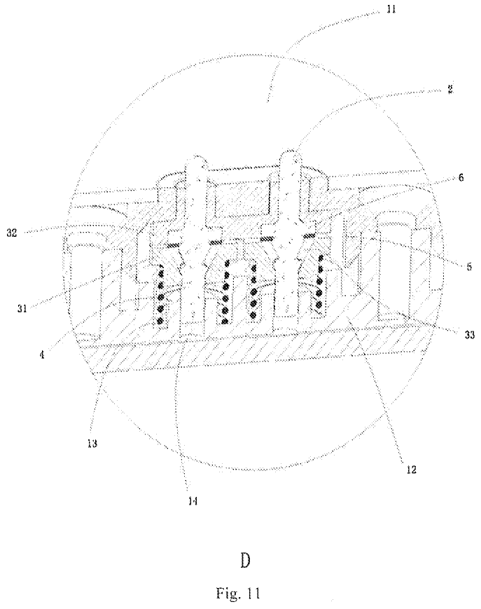

FIG. 11 is a partial enlarged view of D in FIG. 10.

### EMBODIMENTS OF THE INVENTION

### Embodiments of the Present Invention

In order to more clearly understand the technical issues to be resolved, technical solutions, and beneficial effects of the present application, the present application is further described in combination with the attached drawings and embodiments as follows. It should be understood that the specific embodiments described herein are merely used to explain the present application and may not be used to limit the present application.

A multifunctional heating and heat preservation container, as shown in FIG. 1-FIG. 3, comprises a container main body 30; the container main body 30 comprises a container inner lining 8; a containing housing 10, which forms a vacuum cavity 9 with the container inner lining 8, is arranged on the peripheral side of the container inner lining 8.

The container housing 10 does not cover the bottom of the container inner lining 8. The cavity formed by the container inner lining 8 and the container housing 10 is the vacuum cavity 9, which has the heat preservation function because of its insulation of air. With this structure, the physical heat preservation function of the vacuum cavity 9 is leveraged to reduce the speed of decline of the temperature of the water or other liquids placed in the container inner lining 8 so that the matching temperature control bottom of the container does not have to continually heat the container main body 8 to maintain a constant temperature, which reduces power consumption and improves the battery life. The problems, whereby a cup body of an existing temperature control cup uses a single-layer steel plate structure, the cup body dissipates heat quickly, and heat preservation completely depends on electric heating so that a battery, which is in the temperature control bottom of the container and is used for power supply, consumes electricity quickly, are solved.

A vacuum hole is opened on the container main body 30 to realize the process of vacuuming the air in the vacuum cavity 9 so that it has the physical heat preservation function.

As it can be seen in a multifunctional heating and heat preservation container, as shown in FIG. 1-FIG. 3, a container support 16, which is bent and fitted on the side wall of the container inner lining 8, is further arranged on the container inner lining 8; the container support 16 has a cavity to expose the bottom of the container inner lining 8; the container support 16 is fixed on the side wall of the container inner lining 8 by an angular welding process; a connecting plate 17 is arranged between the container support 16 and the container housing 10; the cross section of the connecting plate 17 is of a U shape; the two ends of the connecting plate 17 are fixated on the container housing 10 and the container support 16 respectively by an angular welding process. As seen in the figures, the vacuum cavity 9 is formed by welding the container housing 10, the container support 16, the connecting plate 17, and the side wall of the container inner lining 8 and the vacuuming process. Welding individual plates to assemble and form the structure of the vacuum cavity 9 solves the problem of the high defective rate when the container housing 10 is directly welded on the containing inner lining 8 to form the vacuum cavity 9 and at the same time avoids the problem of the unappealing appearance of a fillet formed by the bending of the container housing 10. At the same time, it enables the vacuum cavity 9 to extend to the bottom and further enlarges the size of the vacuum cavity 9, which further improves the heat preservation effect of the container.

FIG. 4 shows an embodiment of a multifunctional heating and heat preservation container,

The only difference from the embodiment above is the shape of the connecting plate 17. As it can be seen in the figure, one end of the connecting plate 17 close to the container support 16 is bent and extends into the vacuum cavity 9; the connecting plate 17 and the support 16 are tightly fitted by welding. As it can be seen in a multifunctional heating and heat preservation container shown in FIG. 6-FIG. 7, a container support 16, which is bent and fitted on the side plate of the container inner lining 8, is further arranged on the container inner lining 8; one end of the container support 16 away from the container inner lining 8 is connected on the container housing 10; the two ends of the container support 16 are welded on the container inner lining 8 and the container housing 10 by an angular welding process; the vacuum cavity 9 is formed by welding the container housing 10, the container support 16, and the side wall of the container inner lining 8 and the vacuuming process. Welding individual plates to assemble and form the structure of the vacuum cavity 9 solves the problem of the high defective rate when the container housing 10 is directly welded on the containing inner lining 8 to form the vacuum cavity 9 and at the same time avoids the problem of the unappealing appearance of a fillet formed by the bending of the container housing 10. At the same time, it enables the vacuum cavity 9 to extend to the bottom and further enlarges the size of the vacuum cavity 9, which further improves the heat preservation effect of the container.

As it can be known from a multifunctional heating and heat preservation container shown in FIG. 1-FIG. 2, a heating element 211 is arranged on the container inner lining 8; a temperature control bottom of the container 31 for heating the container main body 30 is arranged on the container main body 30; the temperature control bottom of the container 31 comprises a base housing 20 arranged on the container housing 10; a power supply 21 to supply power to the heating element 211 is arranged in the base housing 20; the power supply 21 comprises a battery 212 arranged in the base housing 20; the battery 212 is electrically connected to a control mainboard 213, a charging ring 214, and heating element 211; one side of the heating ring 214 extends to the exterior of the base housing 20; a switch 23 for turning on and off the battery 212 is arranged on the base housing 20. A support for fixating the battery 212 is arranged in the container housing 10; an insulating layer is arranged between the battery 212 and the heating element 211. This structure is used, as the structure is compact and reasonable.

As it can be known from a multifunctional heating and heat preservation container shown in FIG. 1-FIG. 2, a temperature adjustment touch piece 24 for adjusting temperature is arranged on a side wall of the base housing 20. A user may intuitively adjust to the required temperature using the temperature adjustment touch piece 24; at the same time, the temperature adjustment touch piece 24 is arranged on the side wall of the base housing 20 to avoid accidental touch by the user.

A base charger matching a multifunctional heating and heat preservation container, as shown in FIG. 8-FIG. 11, comprises a base housing 1; an ejector pin 2, which is in contact with a charging ring 214, is arranged in the base housing 1; an insulating layer 3 is sleeved on the ejector pin 2; an elastic member 4, which elastically ejects the ejector pin 2 towards the outside of the base housing 1 to enable the ejector pin 2 to move out of or retract into the base housing 1, is sleeved on the insulating layer 3; a conductive terminal 5 is connected to the ejector pin 3 [sic: 2]. As it can be seen in the figures, the elastic member 4 is sleeved on the insulating layer 3; the elastic member 4 ejects the ejector pin 2 towards the outside of the base housing 1 to enable the ejector pin 2 to move out of or retract into the base housing 1; the ejector pin 2 is electrically connected to an external circuit via the conductive terminal 5 arranged thereon. No electric current passes through the elastic member 4 when the ejector pin 2 is electrically connected to an external circuit. With this structure, the problems, whereby a spring in an existing charging base is arranged in an ejector pin, and the spring is prone to failure due to an excessive current in the external power-on process of the charging base so that the ejector pin cannot rebound and reset, are solved, and the circumstance that the spring loses its elasticity and the ejector pin cannot successfully move out of or retract into the base housing 1 is avoided.

As it can be known from a base charger matching a multifunctional heating and heat preservation container shown in FIG. 8-FIG. 11, the base housing 1 further comprises a top base housing 11 and a bottom base housing 12 covering the top base housing 11; a ring groove 13 for placing the elastic member 4 is arranged on the bottom base housing 12; the ejector pin 2 is arranged in a mounting hole 14 formed by the ring groove 13. With this structure, the mounting hole 14 formed by the ring grove 13 and the ring groove 13 plays the role of fixating the elastic member 4 and the ejector pin 2 so that the structure is more stable and reliable.

As it can be known from a base charger matching a multifunctional heating and heat preservation container shown in FIG. 8-FIG. 11, the insulating layer 3 further comprises a bottom insulating layer 31 and a top insulating layer 32 arranged on the bottom insulating layer 31; the conductive terminal 5 is arranged between the bottom insulating layer 31 and the top insulating layer 32; the elastic member 4 is sleeved on the bottom insulating layer 31. With this structure, while the electric connection between the ejector pin 2 and an external circuit is realized, the objective that the elastic member 4 is not in contact with current is also realized; the conductive terminal 5 is arranged between the bottom insulating layer 31 and the insulating layer [sic: top insulating layer] 32; the conductive terminal 5 avoids contact with other components, which improves safety; the insulating layer 3 may be made of heat resistant silica gel.

As it can be known from a base charger matching a multifunctional heating and heat preservation container shown in FIG. 8-FIG. 11, a through hole 33, which gradually enlarges towards the direction of the conductive terminal 5 is arranged on the bottom insulating layer 31; the ejector pin 2 is fitted in the through hole. The conductive terminal 5 and the ejector pin 2 are fixated by welding; there is enough room left in the through hole 33 for a soldering location. With this structure, the stability of the conductive terminal 5 is improved, preventing the movement of the conductive terminal 5.

As it can be known from a base charger matching a multifunctional heating and heat preservation container shown in FIG. 8-FIG. 11, a limit block 6 for controlling the height of the ejector pin 2 extending outside the base housing 1 is arranged on the ejector pin 2. The detailed structure of the limit block 6 is shown in the figures; the limit block 6 extends outwards along the periphery of the ejector pin 2 so that while the ejector pin 2 cannot completely be free from the housing 1, the specific location of the limit block 6 can be adjusted to control the extended height of the ejector pin 2; with this structure, the stability and safety of the structure is improved.

A multifunctional heating and heat preservation container combination comprises a lid; the lid covers the multifunctional heating and heat preservation container above; the multifunctional heating and heat preservation container is placed on the charging base matching the multifunctional heating and heat preservation container above. With this combination, the problems, whereby a cup body of an existing temperature control cup uses a single-layer steel plate structure, the cup body dissipates heat quickly, and heat preservation completely depends on electric heating so that a battery, which is in the temperature control bottom of the container and is used for power supply, consumes electricity quickly, a spring in a charging base is arranged in an ejector pin, and the spring is prone to failure due to an excessive current in the external power-on process of the charging base so that the ejector pin cannot rebound and reset, are solved.

The operating principles of a multifunctional heating and heat preservation container of the present utility model are as follows:

The present utility model provides a multifunctional heating and heat preservation container, comprising a container main body; the container main body comprises a container inner lining and a container housing; the container housing and the container inner lining form a vacuum cavity, and the container housing does not cover the bottom of the container inner lining. With this structure, the physical characteristic that the vacuum cavity does not conduct heat is leveraged to reduce the speed of decline of the temperature of the water or other liquids placed in the container inner lining so that the matching temperature control bottom of the container does not have to continually heat the container main body to maintain a constant temperature, which reduces power consumption and improves the battery life. The problems, whereby a cup body of an existing temperature control cup uses a single-layer steel plate structure, the cup body dissipates heat quickly, and heat preservation completely depends on electric heating so that a battery, which is in the temperature control bottom of the container and is used for power supply, consumes electricity quickly, are solved.

The present utility model provides a charging base matching the multifunctional heating and heat preservation container, comprising a base housing and an ejector pin in the base housing; an insulating layer is sleeved on the ejector pin; an elastic member is sleeved on the insulating layer; the elastic member, which elastically ejects the ejector pin towards the outside of the base housing to enable the ejector pin to move out of or retract into the base housing; the ejector pin is electrically connected to an external circuit via the conductive terminal arranged thereon. No electricity passes through the elastic member while the ejector pin is electrically connected to an external circuit; with this structure, the problems in the state of the art, whereby a spring in an existing charging base is arranged in an ejector pin, and the spring is prone to failure due to an excessive current in the external power-on process of the charging base, are solved, and the circumstance that the spring loses its elasticity and the ejector pin cannot successfully move out of or retract into the housing is avoided.

It should be understood that the present application uses terms, such as “first” and “second,” to describe various types of information, but such information shall not be limited by such terms. These terms shall merely be used to differentiate the same type of information. For example, without exceeding the scope of the present application, the “first” information may also be referred to as the “second” information. Furthermore, the position or location relationships indicated by “center,” “top,” “bottom,” “left,” “right,” “vertical,” “horizontal,” “inside,” “outside” and other terms are based on the position or location relationships shown in the attached drawings. They are merely for the ease of describing the present application and simplifying the description, and do not indicate or imply that the device or component must have a specific position and be constructed and operated in a specific location. Thus, they may not be understood as limitations to the present application.

The description above provides one or a plurality of embodiments by combining the specifics; it may not be recognized that the specific implementation of the present application is only limited to such description. Certain technical deductions or replacements, as long as they are similar to or same as the methods and structures of the present application or they are made based on the ideas of the present application, shall be considered as the scope protected by the present application.

What is claimed is:

1. A multifunctional heating and heat preservation container, comprising a container main body (30), characterized in that the container main body (30) comprises a container inner lining (8); a containing housing (10), which forms a vacuum cavity (9) with the container inner lining (8) and enables the bottom of the container inner lining (8) to be exposed, is arranged on the peripheral side of the container inner lining (8).

2. A multifunctional heating and heat preservation container as described in claim 1, characterized in that a container support (16), which enables the bottom of the container inner lining (8) to be exposed, is arranged on the container inner lining (8); a connecting plate (17) is arranged between the container housing (10) and the container support (16); the container housing (10), the container support (16), the connecting plate (17), and the side walls of the container inner lining (8) are assembled to form the vacuum cavity (9).

3. A multifunctional heating and heat preservation container as described in claim 2, characterized in that the connecting plate (17) bends upward or downward close to one end of the container support (16).

4. A multifunctional heating and heat preservation container as described in claim 1, characterized in that a container support (16), which enables the bottom of the container inner lining (8) to be exposed, is arranged on the container inner lining (8); one end of the container support (16), which is far from the container inner lining (8), is connected to the container housing (10); the container housing (10), the container support (16), and the side walls of the container inner lining (8) are assembled to form the vacuum cavity (9).

5. A multifunctional heating and heat preservation container as described in claim 1, characterized in that a heating element (211) is arranged on the container inner lining (8); a temperature control bottom of the container (31) for heating the container main body (30) is arranged on the container main body (30); the temperature control bottom of the container (31) comprises a base housing (20) arranged on the container housing (10); a power supply (21) for supplying power to the heating element (211) is arranged in the base housing (20); the power supply (21) comprises a battery (212) arranged in the base housing (20); the battery (212) is electrically connected to a control mainboard (213), a charging ring (214), and the heating element (211); one side of the heating ring (214) extends to the exterior of the base housing (20); a switch (23) for turning on and off the battery (212) is arranged on the base housing (20); a temperature adjustment touch piece (24) for adjusting the heating temperature is arranged on the base housing (20).

6. A charging base matching a multifunctional heating and heat preservation container, characterized in that it comprises a base housing (1); an ejector pin (2), which is in contact with the charging ring (214) is arranged in the base housing (1); an insulating layer (3) is sleeved on the ejector pin (2); an elastic member (4), which elastically ejects the ejector pin (2) towards the outside of the base housing (1) to enable the ejector pin (2) to move out of or retract into the base housing (1), is sleeved on the insulating layer (3); a conductive terminal (5) is connected to the ejector pin (2).

7. A charging base matching a multifunctional heating and heat preservation container as described in claim 6, characterized in that the base housing (1) comprises a top base housing (11) and a bottom base housing (12) covering the top base housing (11); a ring groove (13) for placing the elastic member (4) is arranged on the bottom base housing (12); the ejector pin (2) is arranged in a mounting hole (14) formed by the ring groove (13).

8. A charging base matching a multifunctional heating and heat preservation container as described in claim 7, characterized in that the insulating layer (3) comprises a bottom insulating layer (31) and a top insulating layer (32) arranged on the bottom insulating layer (31); the conductive terminal (5) is arranged between the bottom insulating layer (31) and the top insulating layer (32); the elastic member (4) is sleeved on the bottom insulating layer (31).

9. A charging base matching a multifunctional heating and heat preservation container as described in claim 8, characterized in that a through hole (33), which gradually enlarges towards the direction of the conductive terminal (5) is arranged on the bottom insulating layer (31); the ejector pin (2) is fitted in the through hole (33); a limit block (6) for controlling the height of the ejector pin (2) extending outside the base housing (1) is arranged on the ejector pin (2).

10. A multifunctional heating and heat preservation container combination, characterized in that it comprises a charging base comprising:
a base housing (1);
an ejector pin (2), which is in contact with a charging ring (214) arranged in the base housing (1);
an insulating layer (3) sleeved on the elector pin (2);
an elastic member (4), which elastically ejects the ejector pin (2) towards the outside of the base housing (1) to enable the ejector pin (2) to move out of or retract into the base housing (1), sleeved on the insulating layer (3); and
a conductive terminal (5) connected to the elector pin (2);
wherein the multifunctional heating and heat preservation container as described in claim 1 is arranged on the charging base of the multifunctional heating and heat preservation container.
